(19) United States
(12) Patent Application Publication
(10) Pub. No.: US 2010/0186611 A1
(43) Pub. Date: Jul. 29, 2010

(54) SCREEN PRINTING APPARATUS AND SCREEN PRINTING METHOD

(75) Inventors: Seiichi Miyahara, Saga (JP); Seikou Abe, Fukuoka (JP); Kunihiko Tokita, Saga (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Osaka (JP)

(21) Appl. No.: 12/279,691

(22) PCT Filed: Dec. 26, 2007
(86) PCT No.: PCT/JP2007/075388

§ 371 Date: Aug. 15, 2008

(30) Foreign Application Priority Data
Dec. 28, 2006 (JP) 2006-354300

(51) Int. Cl. B05C 17/10

(52) U.S. Cl. 101/127; 101/129

(57) ABSTRACT

A screen printing apparatus and a screen printing method facilitating to adjust a state of filling a paste. By adjusting a pneumatic pressure of pressing a squeezee 9a formed with a flexible region at at least a portion thereof to a surface of a mask 2, the squeezee 9a is moved up and down to follow recesses and projections of a surface of the mask 2 substantially in real time and an attack angle θ in sliding is maintained substantially constant. Thereby, a state of filling a paste can be stabilized without being influenced by recesses and projections of the surface of the mask 2 and promotion of a print quality can be expected. Further, bending is produced at the squeezee 9a by only adjusting the pneumatic pressure, and therefore, an attack angle θ in correspondence with a change in a print condition of a kind or a property of the paste, a thickness of the mask and the like can easily be changed.

### TECHNICAL FIELD

The present invention relates to a screen printing apparatus and a screen printing method for pattern-printing a paste of a cream solder or the like on a board.

### BACKGROUND ART

In a screen printing, there is adopted a method of pattern-printing a paste of a cream solder or the like on a surface of a board by filling the paste into pattern holes formed at a mask, and therefore, it is important in view of a print quality control to maintain a state of filling the paste constant. The state of filling the paste depends mainly on an elevation angle of a squeezee relative to a surface of the mask referred to as an attack angle, and therefore, in a background art, there are proposed techniques of maintaining the attack angle constant (refer to Patent Reference 1). According to this reference, by pressing a squeezee one face of which is supported by a holder to restrict bending thereof to a surface of a mask by a pneumatic pressure, the squeezee brought into a state of maintaining a constant attack angle is made to follow recesses and projections of the surface of the mask.

Patent Reference 1: JP-A-8-318613

### DISCLOSURE OF THE INVENTION

However, although when a condition of a kind or a property of the paste, a thickness of the mask or the like is changed, it is necessary to adjust the state of filling the paste in accordance with a change in the condition, according to the background art, an angle of attaching the holder per se needs to be changed in order to adjust the attack angle. Therefore, time and labor are taken for a changing operation or an initial setting after the change.

Hence, it is an object of the invention to provide a screen printing apparatus and a screen printing method facilitating to adjust a state of filling a paste.

A screen printing apparatus according to the invention includes a mask formed with a pattern hole filled with a paste, a squeezee slid on a surface of the mask and capable of adjusting an attack angle to the surface of the mask by producing bending at a flexible region formed at at least a portion thereof, and pressing means for pressing the squeezee to the surface of the mask by a pneumatic pressure, wherein the attack angle to the squeezee relative to the surface of the mask is adjusted by adjusting the pneumatic pressure.

A screen printing method according to the invention slides a squeezee formed with a flexible region at at least a portion thereof on a surface of a mask formed with a pattern hole while being pressed thereto, and fills a paste to the pattern hole in a state of maintaining an attack angle of the squeezee relative to the surface of the mask constant.

According to the invention, the squeezee is moved up and down to follow recesses and projections of the surface of the mask substantially in real time by adjusting the pneumatic pressure of pressing the squeezee formed with the flexible region at at least a portion thereof to the surface of the mask and the attack angle in sliding is maintained substantially constant. Thereby, a state of filling the paste can be stabilized without being influenced by recesses and projections of the surface of the mask, and promotion of print quality can be expected. Further, bending is produced in the squeezee by only adjusting the pneumatic pressure, and therefore the attack angle can easily be changed in correspondence with a change in a print condition of a kind or a property of the paste, a thickness of the mask or the like.

### BRIEF DESCRIPTION OF THE DRAWINGS

FIG. 1 is a front view of a screen printing apparatus according to an embodiment of the invention.

FIG. 2 is a front view of the screen printing apparatus according to the embodiment of the invention.

FIG. 3 is a front view of a squeezee unit according to the embodiment of the invention.

FIG. 4 is an explanatory view showing an operation of a squeezee according to the embodiment of the invention.

### BEST MODE FOR CARRYING OUT THE INVENTION

A screen printing apparatus according to an embodiment of the invention will be explained in reference to the drawings.

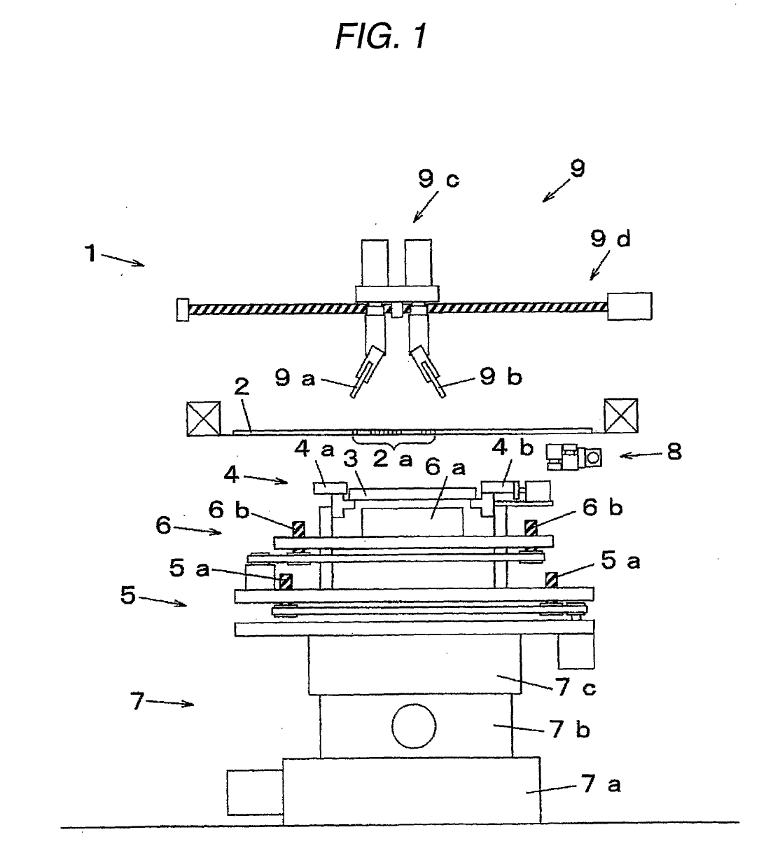

First, the screen printing apparatus will be explained. In FIG. 1, a screen printing apparatus 1 is an apparatus of pattern-printing a paste onto a surface of a printed member 3 positioned to a mask 2 formed with a predetermined pattern hole 2a. The screen printing apparatus 1 is constituted by holding means 4 for holding the printed member 3 at a predetermined position, lifting means 5 for lifting the printed member 3 held by the holding means 4 for bringing and separating a surface of the printed member 3 into contact with and from a back face of the mask 2, supporting means 6 for supporting the printed member 3 from a back face thereof, horizontal moving means 7 for positioning the printed member 3 and the mask by horizontally moving the printed member 3 held by the holding means 4, imaging means 8 for taking images of position recognizing marks (not illustrated) respectively provided at the printed member 3 and the mask 2, and a squeezee unit 9 for filling the paste to the pattern hole 2a of the mask 2.

The holding means 4 is constituted by a clamp mechanism for clamping the printed member 3 from both sides for holding or releasing the board 3 by making a pair of clamp plates 4a, 4b proximate to each other or separate from each other.

The lifting means 5 is constituted by a feed screw mechanism for lifting the clamp mechanism constituting the holding means 4 for bringing and separating the surface of the printed member 3 held by the clamp mechanism into contact with and from the back face of the mask 2 by switching rotation of a feed screw 5a in regular and reverse directions.

The supporting means 6 is constituted by a feed screw mechanism for lifting a support block 6a brought into face contact with the back face of the printed member 3 for bringing and separating a surface of the support block 6a into contact with and from the back face of the printed member 3 by switching rotation of a feed screw 6b in regular and reverse directions.

The horizontal moving means 7 is constituted by laminating an X table 7a and a Y table 7b and a θ table 7c for moving and rotating the printed member 3 held by the clamp mechanism in a horizontal face and positioning the printed member relative to the fixed mask 2 to thereby position the both members.

The imaging means 8 is moved between the mask 2 and the printed member 3 for taking images of position recognizing marks (not illustrated) provided at the mask 2 and the printed member 3 by 2 pieces of CCD cameras 8a, 8b arranged respectively in an up and down direction. When positions of the mask 2 and the printed member 3 relative to each other are recognized by processing data of the taken images and a positional shift therebetween is recognized, a horizontal position of the printed member 3 is corrected by the horizontal moving means 7.

The squeezee unit 9 is constituted by a pair of squeezees 9a, 9b, a lifting mechanism 9c for lifting the squeezees 9a, 9b, and a horizontal moving mechanism 9d for horizontally moving the squeezees 9a, 9b along the surface of the mask 2.

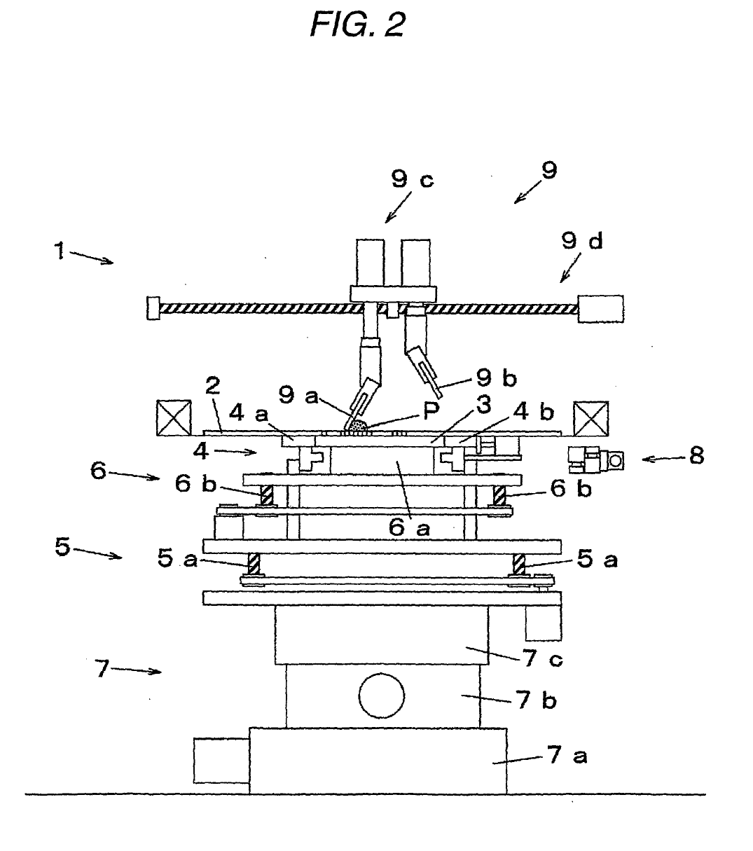

According to the screen printing apparatus 1 constituted in this way, screen printing is carried out as follows. In FIG. 2, the board 3 the printing face 3a of which is lifted up to a height the same as that of surfaces of the clamp plates 4a, 4b is brought into contact with the back face of the mask 2 in a state of being clamped by the clamp plates 4a, 4b from both sides, and the squeezee 9a sliding on the surface of the mask 2 fills a paste P to the pattern hole 2a. When the paste P is filled to all of the pattern holes 2a, sliding of the squeezee 9a is stopped and the board 3 is moved down. Thereby, the back face of the mask 2 and a print face 3a of the board 3 are separated and the paste P filled to the pattern hole is printed to the print face 3a.

The board 3 as printed is carried out from the screen printing apparatus 1 and a new one of the board 3 is carried in in place thereof. Although the new board 3 is similarly subjected to screen printing, the paste P is moved to one side of the mask 2 by the squeezee 9a, and therefore, the squeezee 9b is slid on the surface of the mask 2 in place of the squeezee 9a and the paste P moved to one side by the squeezee 9a is filled to the pattern hole 2a while being moved in a reverse direction along the surface of the mask 2. In this way, a plurality of the boards 3 can be subjected to screen printing by alternately sliding the squeezees 9a, 9b on the surface of the mask 2 at each time of carrying in the new board 3.

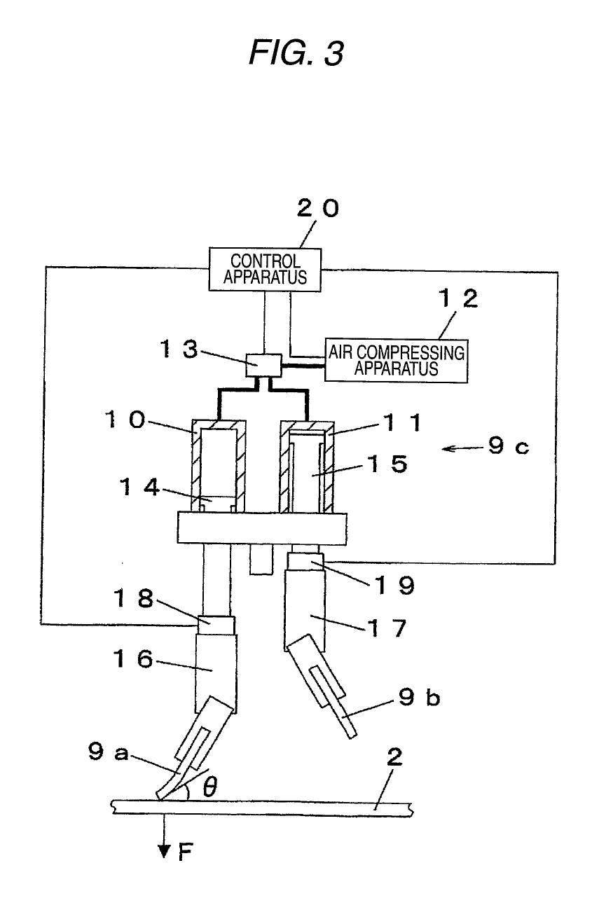

Next, the lifting mechanism will be explained. In FIG. 3, the lifting mechanism 9c is constituted by cylinders 10, 11, and an air pressure compressing apparatus 12 for supplying compressed air to the cylinders 10, 11, and a switch valve 13 for switching a destination of supplying compressed air to either of the cylinders 10 and 11, and piston rods 14, 15 for changing stroke amounts in accordance with pneumatic pressures at inside of the cylinders 10, 11. Front ends of the piston rods 14, 15 are attached with squeezee holders 16, 17 for holding the pair of squeezees 9a, 9b by inclining the squeezees 9a, 9b in directions respectively opposed to each other. When the pneumatic pressure of the cylinder 10 becomes higher than an atmospheric pressure, the piston rod 14 makes a stroke in a lower direction, and a front end of the squeezee 9a is brought into contact with the surface of the mask 2. When compressed air is continued to supply to the cylinder 10 even after the front end of the squeezee 9a is brought into contact with the surface of the mask 2, the pneumatic pressure of the cylinder 10 is increased and the squeezee 9a is pressed to the surface of the mask 2. In this way, the lifting mechanism 9c is functioned as pressing means for pressing the squeezees 9a, 9b to the surface of the mask 2 by the pneumatic pressure.

The squeezees 9a, 9b formed by hard rubber in a plate-like shape are used and are provided with a flexibility, and therefore, bending is brought about at the squeezees 9a, 9b pressed to the surface of the mask 2 in accordance with press forces thereof An attack angle θ relative to the surface of the mask 2 is correlated with an amount of bending the squeezee 9a, and therefore, the attack angle θ can be adjusted by changing a press force F from the squeezee 9a to the surface of the mask 2 by increasing or reducing the pneumatic pressure in the cylinder 10.

Load cells 18, 19 are provided between front ends of the piston rods 14, 15 and the squeezee holders 16, 17. The load cells 18, 19 convert strains produced in a vertical direction by the press force F to the surface of the mask 2 of the squeezee 9a into voltages to transmit to a control apparatus 20. The control apparatus 20 is functioned as detecting means for detecting the press force F for pressing the squeezees 9a, 9b to the surface of the mask 2 based on the voltages transmitted from the load cells 18, 19. Further, the control apparatus 20 can increase or reduce the press force F of an arbitrary one of the squeezees 9a, 9b to the surface of the mask 2 by controlling to drive the air pressure compressing apparatus 12 and the switch valve 13, thereby, the attack angle θ of the arbitrary one of the squeezees 9a, 9b to the surface of the mask 2 can freely be adjusted.

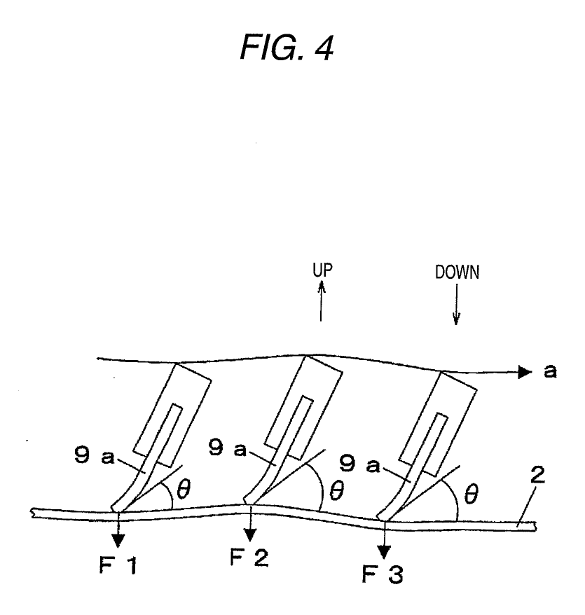

Further, the control apparatus 20 is functioned as pneumatic pressure adjusting means for adjusting a pneumatic pressure based on the detected press force F to carry out a feedback control of restraining a variation in the press force F by increasing or reducing the pneumatic pressure at inside of the cylinder 10 by detecting a variation in the press force F by recesses and projections of the surface of the mask 2 when the squeezee 9a is slid to the surface of the mask 2. In FIG. 4, when there is a warp in a projected shape on the surface of the mask 2 in sliding the squeezee 9a in a state of being pressed to the surface of the mask 2 by a press force F1, a reaction force from the mask 2 to the squeezee 9a is increased, as a result, the press force F is increased from F1 to F2. The control apparatus 20 controls to reduce the pneumatic pressure at inside of the cylinder 10 in order to maintain the press force F2 to the initial press force F1, and therefore, the squeezee 9a is moved up by following the warp in the projected shape of the surface of the mask 2.

Contrary thereto, when there is a warp in a recessed shape on the surface of the mask 2, the reaction force from the mask 2 to the squeezee 9a is reduced, as a result, the press force F is reduced from F1 to F3. The control apparatus 20 controls to reduce the pneumatic pressure at inside of the cylinder 10 in order to maintain the press force F3 to the initial press force F1, and therefore, the squeezee 9a is moved down by following the warp in the recessed shape of the surface of the mask 2. In this way, the squeezee 9a is moved up and down by following recesses and projections of the surface of the mask 2 substantially in real time (refer to an arrow mark a), and therefore, the attack angle θ of the squeezee 9a in sliding is maintained substantially constant. Also in the squeezee 9b, the attack angle θ in sliding is similarly maintained substantially constant.

Further, totals of the squeezees 9a, 9b may not be formed by hard rubber but hard rubber may be arranged between metal squeezees divided in an up and down direction. Further, a metal squeezee having a flexibility will do. That is, there may be constructed a constitution of a mode capable of adjusting the attack angle θ by producing bending in a flexible region formed at at least a portion thereof in correspondence with a change in the press force of F of the squeezees 9a or 9b to the surface of the mask 2.

In this way, by adjusting the pneumatic pressure of pressing the squeezee 9a formed with the flexible region at at least a portion thereof to the surface of the mask 2, the squeezee 9a is moved up and down to follow recesses and projections of the surface of the mask 2 substantially in real time and the attack angle θ in sliding is maintained substantially constant. Thereby, the state of filling the paste can be stabilized without being influenced by recesses and projections of the surface of the mask 2, and promotion of the print quality can be expected. Further, bending is brought about in the squeezee 9a by only adjusting the pneumatic pressure, and therefore, the attack angle θ in correspondence with a change in the printing condition of a kind and a property of the paste, a thickness of the mask and the like can easily be changed.

### INDUSTRIAL APPLICABILITY

According to the invention, by adjusting the pneumatic pressure of pressing the squeezee formed with the flexible region at at least a portion thereof to the surface of the mask, the squeezee is moved up and down to follow recesses and projections of the surface of the mask substantially in real time and the attack angle in sliding is maintained substantially constant. Thereby, the state of filling the paste can be stabilized without being influenced by recesses and projections of the surface of the mask, and promotion of the print quality can be expected. Further, bending is produced in the squeezee by only adjusting the pneumatic pressure, and therefore, there is achieved an advantage of capable of easily changing the attack angle in correspondence with the change in the printing condition of the kind and the property of the paste, the thickness of the mask and the like, which is useful for promotion of the printing quality in a screen printing filed.

This application is based upon and claims the benefit of priority of Japanese Patent Application No. 2006-354300 filed on Dec. 28, 2006, the contents of which are incorporated herein by reference in its entirety.

1. A screen printing apparatus comprising:
a mask formed with pattern holes to which a paste is filled;
a squeezee slid on a surface of the mask and capable of adjusting an attack angle to the surface of the mask by producing bending at a flexible region formed at at least a portion thereof; and
pressing means for pressing the squeezee to the surface of the mask by a pneumatic pressure;
wherein the attack angle to the surface of the mask of the squeezee is adjusted by adjusting the pneumatic pressure.

2. The screen printing apparatus according to claim 1, further comprising:
detecting means for detecting a press force of pressing the squeezee to the surface of the mask; and
pneumatic pressure adjusting means for adjusting the pneumatic pressure based on the press force detected by the detecting means;
wherein the pneumatic pressure adjusting means maintains the attack angle in sliding the squeezee constant by adjusting the pneumatic pressure based on the press force detected by the detecting means when the squeezee is slid on the surface of the mask.

3. A screen printing method of sliding a squeezee formed with a flexible region at at least a portion thereof while pressing the squeezee to a surface of a mask formed with a pattern hole and filling a paste to the pattern hole in a state of maintaining an attack angle of the squeezee relative to the surface of the mask constant.

4. The screen printing method according to claim 3, wherein the squeezee is pressed to the surface of the mask by a pneumatic pressure.

5. The screen printing method according to claim 4, wherein the attack angle of the squeezee relative to the surface of the mask is adjusted by adjusting the pneumatic pressure.

6. The screen printing method according to claim 5, wherein a press force of pressing the squeezee to the surface of the mask is detected and the attack angle in sliding the squeezee is maintained constant by adjusting the pneumatic pressure based on the detected press force.
